(19) United States
(12) Patent Application Publication
(10) Pub. No.: US 2004/0082251 A1
(43) Pub. Date: Apr. 29, 2004

(54) Apparatus for adjustable gas distribution for semiconductor substrate processing

(75) Inventors: Joseph Bach, Morgan Hill, CA (US); Hidetaka Oshio, Narita-Shi (JP)

Correspondence Address: Patent Counsel, APPLIED MATERIALS, INC., P.O. Box 450A, Santa Clara, CA, 95052, US

(73) Assignee: APPLIED MATERIALS, INC.

(21) Appl. No.: 10/283,848

(22) Filed: Oct. 29, 2002

(51) Int. Cl. H01J 9/46

(52) U.S. Cl. 445/60

(57) ABSTRACT

The present invention generally provides a gas distribution system that allows a user to manually or automatically vary the gas distribution into a process chamber and across the substrate surface without having to physically enter the process chamber.

### BACKGROUND OF THE INVENTION

1. Field of the Invention

Embodiments of the present invention generally relate to semiconductor and flat panel display fabrication. Embodiments of the invention are directed to an improved gas distribution assembly that allows the user to change the gas flow distribution across a substrate to improve a film profile.

2. Description of the Related Art

Due to the push to shrink device geometries in the semiconductor and flat panel industries and the ever-increasing competitive need for improved process yields, substrate-processing requirements are becoming increasingly stringent. One such processing requirement is the precise and/or uniform delivery and distribution of gases into the process chamber and across the surface of the substrate being processed.

In a number of substrate processing applications, such as etch, deposition, and thermal processes, it is generally desirable to deliver gases to the wafer in a tailored or uniform manner. In state-of-the-art applications the process gases are generally delivered to the substrate surface through a gas distribution plate that is adjacent to the substrate holder and the substrate surface. The gas distribution plate is positioned over the wafer and includes a pattern of holes that form the gas outlets or ports.

For material removal, or etch type processes, it is generally desirable to have a uniform etch rate (material removal rate) across the substrate surface, since a non-uniform etch rate can adversely affect subsequent processes and the process yield. One such process is the dry etch process, which selectively removes material from the patterned surface of a substrate. The dry etch process involves the introduction of a gas or etch medium, into an etch chamber that is subsequently ionized in a plasma and is directed towards the substrate surface by a bias placed on the substrate support member. Therefore, the tailored or uniform delivery of the process gases, which are typically distributed through a gas distribution plate that is coupled to a gas supply, are critical to the completion of these types of processes.

For processes that deposit material onto the substrate or work piece and are affected by the gas flow distribution, such as chemical vapor deposition (CVD) processes, it is generally desirable to deposit a uniform film profile on the substrate surface, since a non-uniform film can adversely affect subsequent processing steps. CVD processes generally have process variables similar to those of dry etching processes since both involve a gas interacting with the surface of a substrate, causing a reaction at the surface of the substrate and the release of a by-product. Therefore, the delivery of a tailored or uniform flow of gas across the surface of the wafer is an important factor in the completion of material deposition processes.

In a typical state-of-the-art substrate-processing chamber the only method for changing the gas flow distribution across the substrate is to interrupt the chamber process and replace the gas distribution plate (also commonly known as the showerhead). Removal and/or placement of the showerhead requires dismantling of the chamber (breaking the vacuum) causing significant chamber downtime, since conventional processing techniques use a single solid showerhead that cannot be manipulated to vary the gas flow distribution. Conventional showerheads are designed to optimize uniformity over a wide range of process variables and flow regimes. The conventional designs thus tend to balance film uniformity against the utility of the plate design over the range of typical process variables.

Therefore, there is need for the apparatus of the present invention, allowing an operator to easily adjust the gas flow distribution across the surface of a substrate to improve process uniformity and device yield.

### SUMMARY OF THE INVENTION

The present invention generally a gas distribution system that allows a user to manually or automatically vary the gas distribution into a process chamber and across the substrate surface without having to physically enter the process chamber. This is accomplished through manual or automatic manipulation of the gas flow path configuration or through the continuous rotation of the showerhead to average out gas flow distribution and other process variable non-uniformities. The gas distribution on different portions of the substrate can be controlled not only for a single gas, but also for a mixture of different gases used in multiple process steps.

Specifically, in the present invention the gas distribution system for delivery gas to a processing chamber comprises a first plate that is rotationally coupled to the gas inlet port forming an internal plenum into which the incoming gas from a gas source flows. The first plate's bottom surface is opposite to the end in which the gas enters. The first plate contains a plurality of slots that connect the bottom surface to the internal plenum. A gas distribution plate, or showerhead, which is located adjacent to a substrate supporting surface and the bottom surface of the first plate, contains a plurality of one or more sets of radially spaced ports. Therefore the gas flow path into the process area of the chamber is from the gas source, through the gas inlet port, through the slots in the first plate which are in communication with the ports of the showerhead and into the chamber and across the substrate surface. Ports in the showerhead that are not in alignment with the slots in the first plate will be blocked, thus restricting or preventing the transfer of gas through these ports into the chamber and across the substrate surface. The first plate can be manually rotated to the desired port configuration by rotating the first plate by hand or by use of a tool. One embodiment allows the user to orient the first plate in a repeatable manner by use of markings and/or by the use of rotationally spaced mechanical indicators.

In another aspect of the invention, the first plate's rotational position or orientation can be automatically controlled by use of a motor that is rotationally coupled to the first plate. A control system, which contains a controller and mass flow controller, adjusts the rotational position of the first plate relative to the showerhead by use of stored control commands and a control feed back loop. The control system also controls the inlet gas flow rate and gas mixture ratio by use of the mass flow controller.

In another aspect of the invention, the first plate is continually rotated during processing to average out any local non-uniformity created by the injection of gas into the process area by discrete gas ports. The continuous rotation tends to average out any local non-uniformity as seen by any single point on the wafer at any instant of time.

Other advantages, features, and embodiments of the present invention will become apparent from the following detailed descriptions and claims.

### BRIEF DESCRIPTION OF THE DRAWINGS

So that the manner in which the above recited features, advantages and objects of the present invention can be understood in detail, a more particular description of the invention may be had by reference to the embodiments that are described in the specification and are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-section view illustrating a dry etch chamber with gas flow schematic;

FIG. 2 is a cross-section of an embodiment of the dry etch chamber where the gas inlet channel and gas distribution plate are two separate components;

FIG. 3A is an exploded perspective view of the chamber lid assembly for the embodiment as viewed from the bottom of the chamber;

FIG. 3B is an exploded perspective view of the chamber lid assembly for the embodiment as viewed from the wafer support surface;

FIG. 4 is a bottom cross-section view of upper chamber components shown in FIG. 1;

FIG. 5 is a cross-section view from the gas distribution plate and showerhead ports highlighting typical port alignment configurations;

FIG. 6 is a cross-section view of the dry etch chamber with the gas distribution assembly in the up position;

FIG. 7 is a cross-section view of gas inlet port 1 and gas channel plate 2;

FIG. 8 is a cross-section view of the dry etch chamber configured to allow a motor to control the gas distribution assembly portion;

FIG. 9 is a cross-section view of the dry etch chamber configured to allow a motor to continuously rotate the gas distribution assembly;

FIG. 10 is a cross-section view of an aligned gas distribution plate 3 port and a typical state-of-the-art showerhead 5 port;

FIG. 11 is a cross-section view of an aligned gas distribution plate 3 port and a showerhead 5 port which has a non-vertical outlet;

FIG. 12 is a rotational-speed timing diagram showing some possible speed profiles used for the continuously rotating configuration shown in FIG. 9;

FIG. 13 is a cross-section view showing a variation on the embodiment shown in FIG. 1 where the plasma is generated via a capacitively coupled plasma source design.

### DETAILED DESCRIPTION

The present invention has application in many manufacturing processes where the gas flow distribution can affect the characteristics or desired attributes created during the process cycle. One area where this application is particularly important is the semiconductor and flat panel display industries. Dry etch, chemical vapor deposition (CVD), and thermal processes are examples of typical processes where the uniformity of the process is dependent on the distribution of gas across the substrate surface. The present invention improves the uniformity of an etch, deposition or thermal process by adjusting gas flow distribution across a substrate by allowing a user to change the gas injection port configuration to suit a given process condition. The adjustment of the gas outlet configuration allows the user to vary and/or tailor the gas flow pattern to improve the final process results. Embodiments of the present invention can be configured to deliver a non-uniform, or “tailored,” gas flow distribution that matches or compensates for other process variables that can affect the etch or deposition process. Such variables include but are not limited to plasma non-uniformity, substrate temperature non-uniformity, variations in gas concentration across the substrate, gas flow rate, electric field strength, or mask pattern.

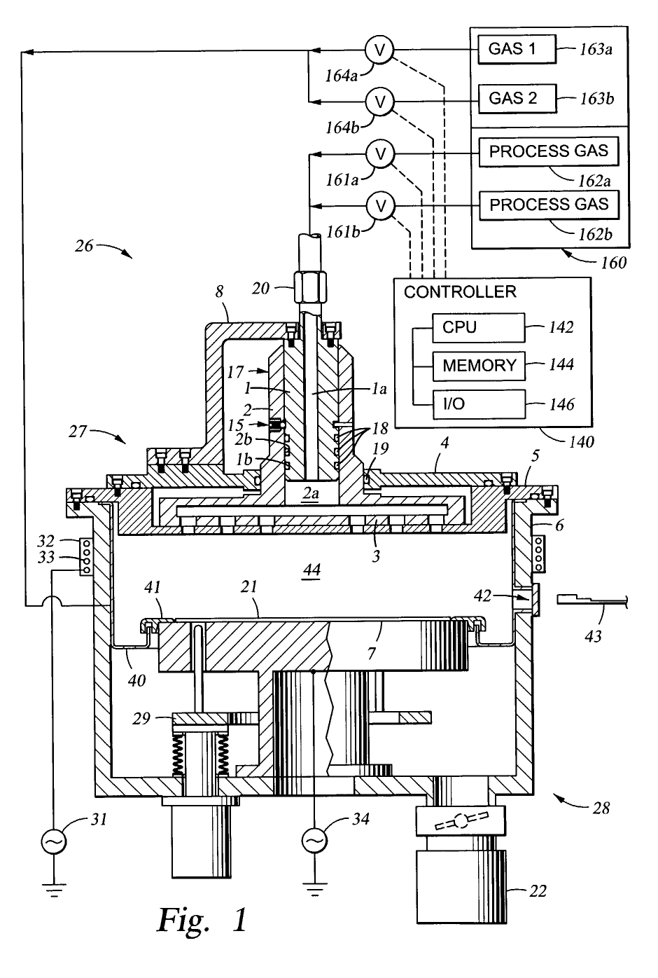

FIG. 1 is a cross-sectional view of an exemplary process chamber 26. This design generally conforms to the eMAX™ Etch tool available from Applied Materials Inc. of Santa Clara, Calif. However, embodiments of the invention have application in other chambers as well. Exemplary chambers include etch and CVD chambers such as the eMax™ etch, DPS™ etch, Ultima™ HDP-CVD, Producer™, and AKT families of products from Applied Materials Inc. of Santa Clara, Calif.

The process chamber 26 is generally comprised of two main assemblies, a lower chamber assembly 28 and a lid assembly 27. The lid assembly 27 can be pivoted or lifted (not shown) from its process position, sealed against the chamber body 6, to allow the user access to the internal chamber components so that maintenance and cleaning can be completed as needed.

The lower chamber assembly 28 generally includes a substrate lift mechanism 29, a substrate support member 7, a process shield 40, a cover ring 41 and a slit valve assembly 42. The substrate lift mechanism 29 is employed to remove a substrate 21 from a transfer robot 43 and position the substrate 21 on the substrate support member 7 prior to the start of the chamber process and then reverse the sequence after the chamber process has been completed. The transfer robot 43 enters and exits the process chamber 26 through the slit valve assembly 42, which seals the process chamber 26 off from the substrate transfer area of the system (not shown), outside the process chamber 26, during processing. A process shield 40 and cover ring 41 reside in the chamber to collect chamber by-products and/or contain the plasma generated in a process area 44 of the chamber, so as to not contaminate or damage other chamber components.

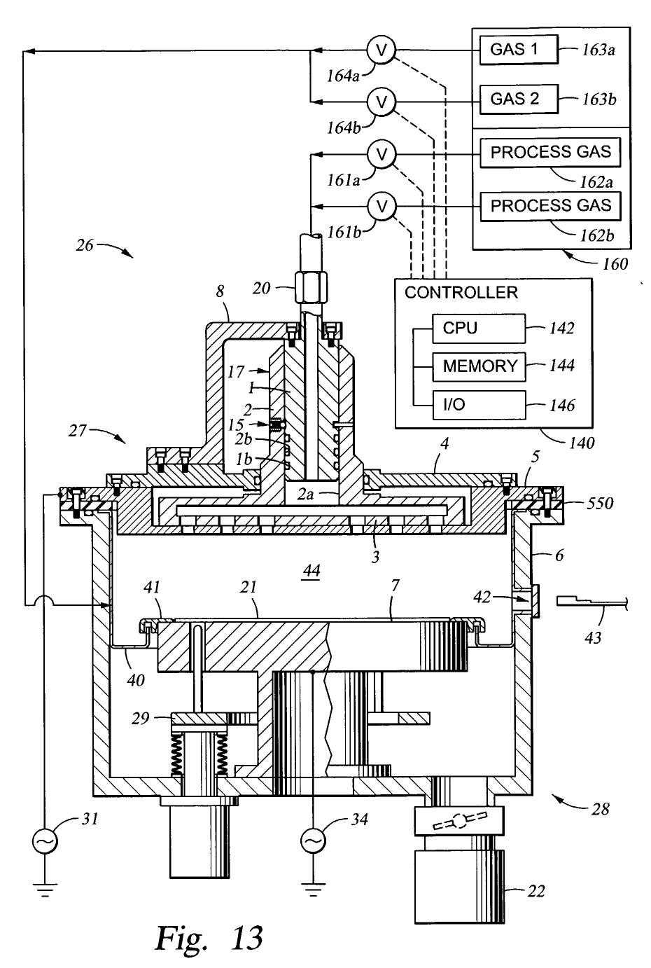

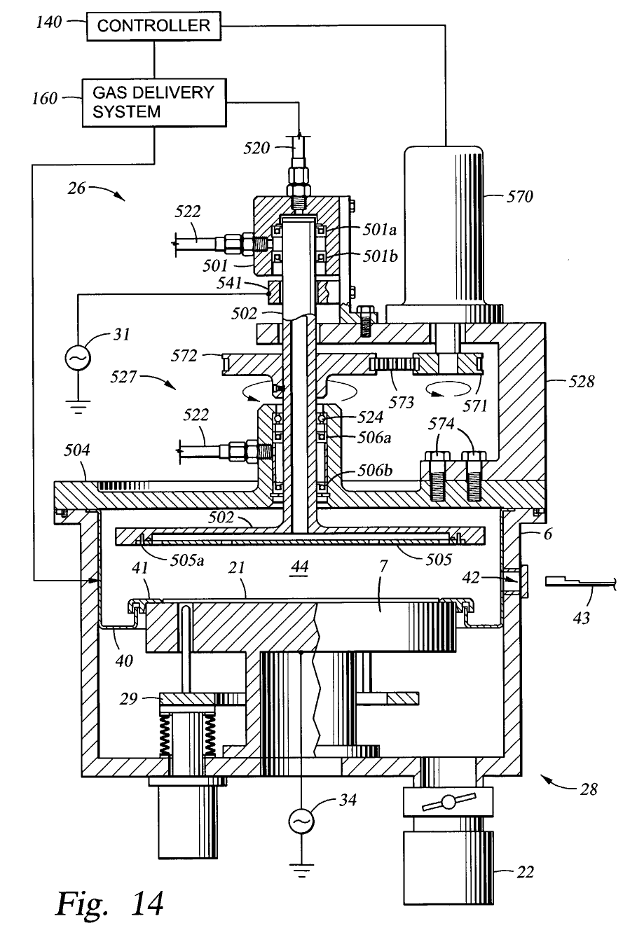

The process area 44 is generally the area above the surface of the substrate 21, below a showerhead 5 and enclosed between the process shield 40, cover ring 41 and the substrate support member 7. The reactive gases and other process gases enter the process area 44 through the showerhead 5 and in some embodiments are ionized through use of a capacitively- or inductively-coupled plasma source. Examples of embodiments of an inductively-coupled design can be seen in FIG. 1 and an example of capacitively-coupled chamber design embodiments can be seen in FIGS. 13 and 14.

Further, for plasma-enhanced processes, such as dry etch and plasma-enhanced CVD (PECVD) processes, the substrate 21 to be processed is mounted on a cathode (or substrate support member 7). An electric field is created between the cathode (substrate support member 7) and an anode, such as the walls of the chamber body 6 (or process shield 40), which, when strong enough, excites the gas to generate a plasma. The generated plasma breaks down the incoming gas from the gas distribution plate into chemically reactive species. Also, the plasma ionizes the gas, allowing the applied electric field to direct the highly mobile ions towards the cathode and thus the substrate 21. The highly reactive and energetic gas ions strike and react with the substrate surface, forming a volatile reaction product that ultimately dissociates from the surface of the substrate. In some applications, the plasma also creates a sputtering effect. Sputtering refers to the effect of the ions striking the substrate surface with sufficient energy to cause physical removal of the exposed surface material(s). A molecular pump (vacuum pump 22) removes the reaction products and gases from the chamber.

An inductive coil 33 and coil support 32 surround the chamber body 6 and power is supplied to the inductive coil 33 from a RF source 31 with power, for example, of 1.0 kW at a frequency of 13.56 MHz. The inductive coil contains and controls the density and uniformity of the generated plasma in the chamber. The chamber components adjacent to the inductive coil 33 are generally comprised of non-magnetic materials (e.g., anodized aluminum, ceramic materials, plastics, etc.) such that the magnetic field lines (not shown) induced from the RF power, generated in the RF source 31 and passing through the inductive coil 33, is allowed to be freely transmitted to shape and control the plasma.

During processing, the substrate 21 is positioned on the top surface of the substrate support member 7, which is heated or cooled as required by the process. For etch processing chambers, the preferred configuration is usually to cool the substrate below the steady state processing temperature. In a CVD process, however, the support member is preferably heated. In dry etching and PECVD processes a RF power supply 34 is connected to the substrate support member 7 to bias the pedestal electrode and thus extract the ions from the plasma generated in the chamber. The use of a vacuum pump 22 and a gas source assembly 160 allow the pressure in the process area 44 to be held at a sub-atmospheric pressure of between 1 millitorr to 20 torr.

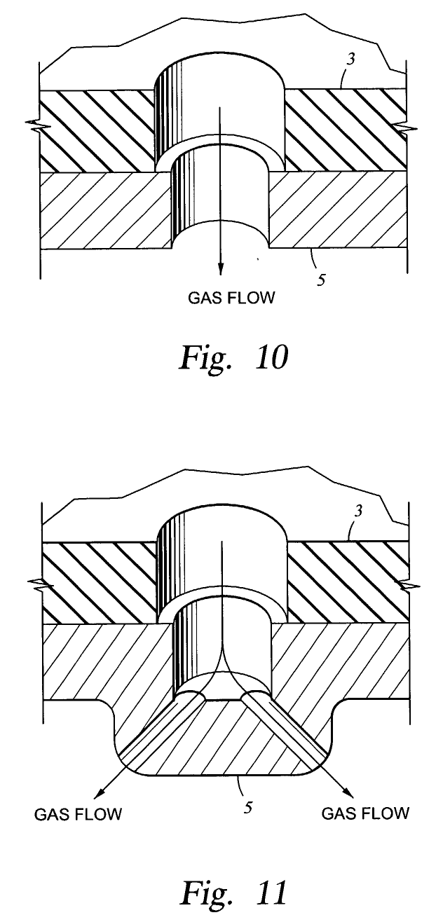

FIG. 1 also shows a typical gas flow schematic for a dry etch or CVD chamber design. The controlled gas mixture ratio and flow through the showerhead 5 can typically be accomplished through a computer-based control system 140. The control system 140 controls a plurality of mass flow controllers (MFCs) such as 161a-161b from the primary gas source 162. It is also possible that the process requires the use an additional or secondary gas source 163 that feeds the chamber to prevent the reactant from attacking or depositing on the chamber walls. The secondary source may also make use of a plurality of computer-controlled MFCs such as 164a-164b to control and maintain a steady gas flow into the chamber. The bulk of the process gases will be delivered through a plurality of holes in the showerhead 5, which are substantially perpendicular and physically adjacent to the substrate 21 that resides on the substrate support member 7, as shown in FIG. 1. FIG. 11 describes another possible embodiment where the plurality of ports 5a, 5b and 5c (which are generally shown in FIG. 10) are modified to change the direction of the gas entering the chamber to improve the gas flow distribution across the substrate 21.

The preferred embodiment shown in also highlights the major components of the lid assembly 27, which generally contains a showerhead 5, chamber lid 4, gas inlet manifold 1, gas distribution plate 3, gas channel plate 2, gas inlet connection 20, and the gas manifold support member 8. When the process chamber 26 is ready to process wafers the lid assembly 27 is down and the showerhead 5 is mounted and seals through the use of o-rings 6a to the top surface of chamber body 6 of the lower chamber assembly 28. The chamber lid 4 encloses the top of the chamber since it mounts and seals to the top of the showerhead 5. The gas manifold support member 8 supports the gas inlet manifold 1 and is attached to the chamber lid 4.

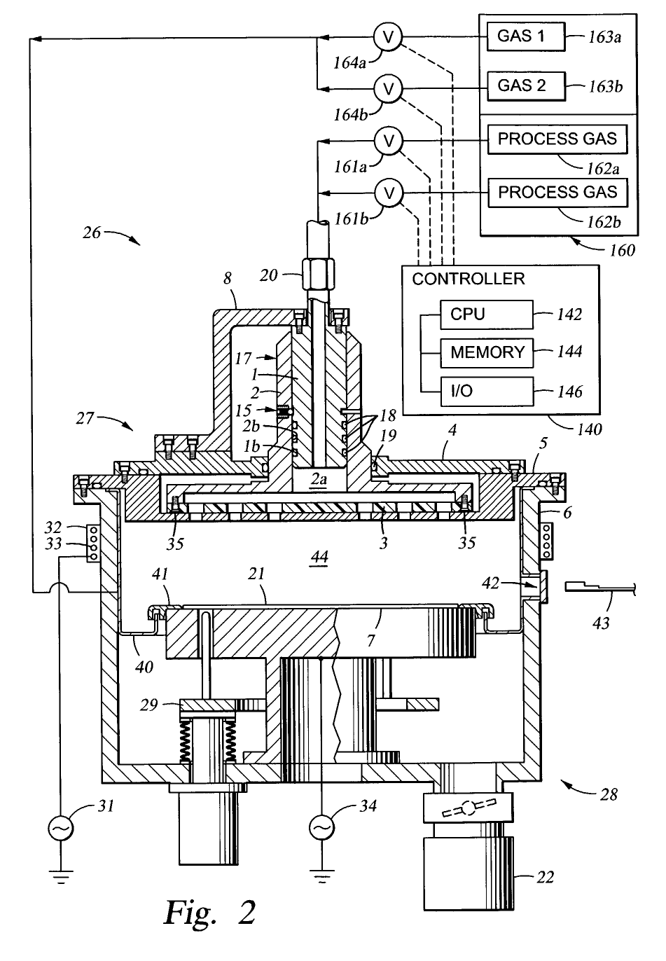

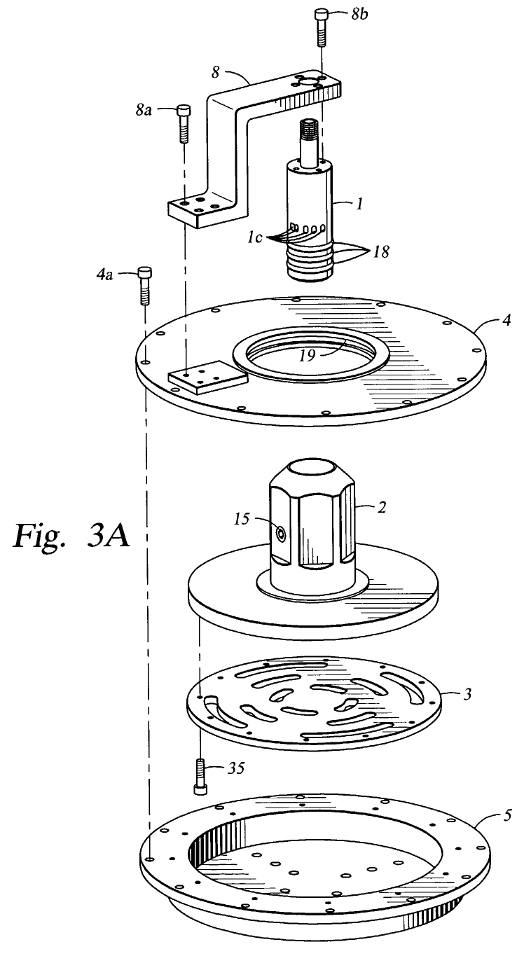

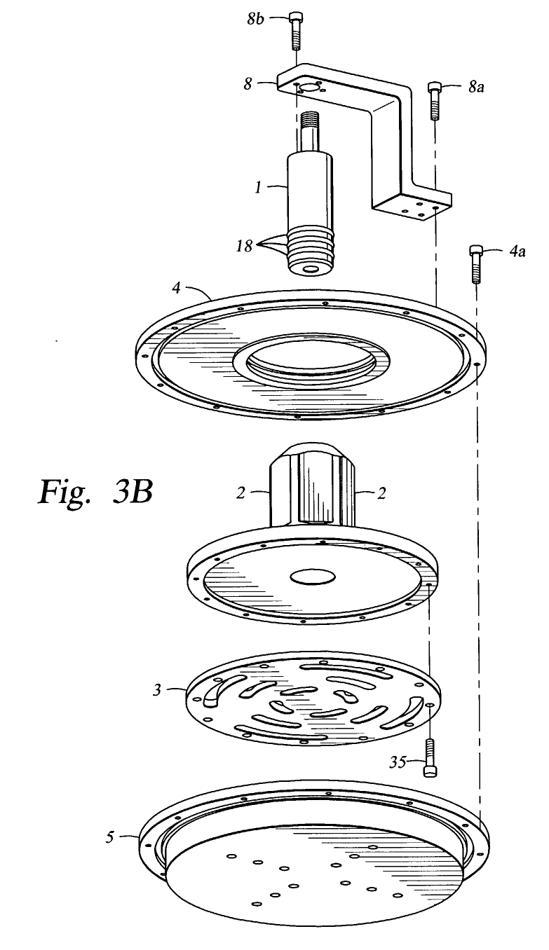

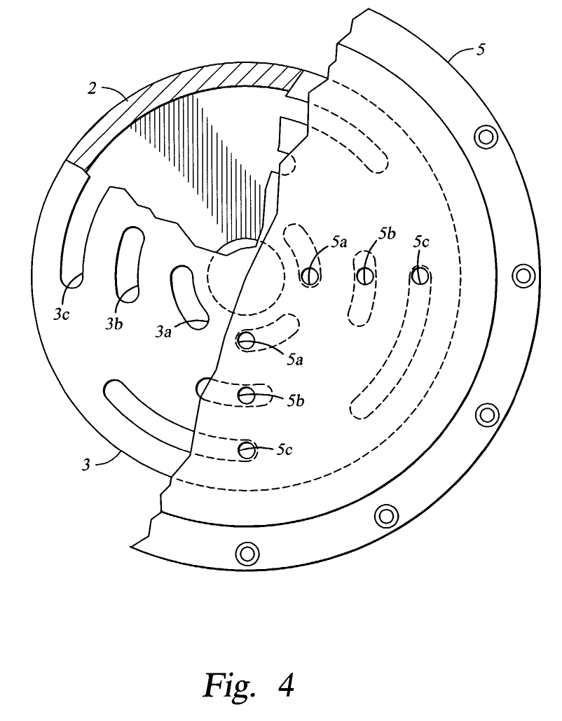

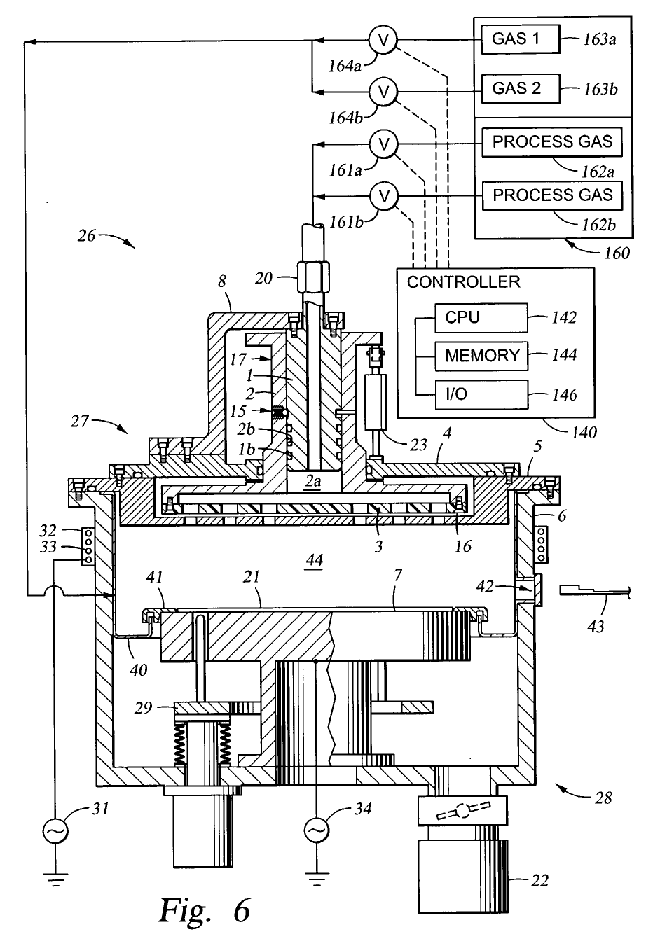

The gas distribution system The gas distribution assembly 17 in FIG. 6 consists of the gas channel plate 2 and the gas distribution plate 3. In one embodiment, as shown in FIG. 1, the gas channel plate 2 and the gas distribution plate 3 are one inseparable part or assembly. FIG. 2 is a cross-sectional view of another embodiment where the gas distribution plate 3 is mounted to the gas channel plate 2 by use of bolts 35 allowing the user to change the gas distribution plate 3 out as required (FIGS. 3A and 3B further illustrate this embodiment). These embodiments allow the gas distribution assembly 17 to be rotated to various positions about the axis of the gas inlet manifold 1 allowing the slots in the gas distribution plate 3 to align and communicate with the desired ports in the showerhead 5. The gas channel plate 2, contained in the gas distribution assembly, is positioned onto the gas inlet manifold 1 and forms a seal between the gas inlet manifold 1 and the chamber lid 4. The seal is maintained between the rotatable gas channel plate 2 and the gas inlet manifold 1 by use of a radial seal 18, which seals against the inner diameter 2b of the gas channel plate 2 and a sealing surface 1b on the gas inlet manifold. A plurality of seals are preferably shown in FIG. 1 to prevent atmospheric leakage into the chamber, although a single seal is capable of meeting this requirement. A second radial seal 19 is disposed between the gas channel plate 2 and the stationary chamber lid 4 to prevent atmospheric leakage into the chamber and allow the gas channel plate 2 to rotate. Multiple disposed radial seals 19 between the chamber lid 4 and the gas channel plate 2 to reduce the possibility of atmospheric leakage also may be used.

During processing, a gas or mixture of gases, supplied from the gas source 162, is delivered into the gas inlet manifold 1 through the gas inlet connection 20. The incoming gases flow through an inner gas channel 1a and exit into the distribution plenum 2a of the gas channel plate 2. The gases then exit the plenum 2a through the aligned holes or slots in the gas distribution plate 3 and the showerhead 5. Thus the gases are allowed to flow freely through the aligned gas distribution plate 3 and the ports in the showerhead 5 into the process area 44 and across the surface of the substrate 21. Seals to prevent gas leakage between the gas distribution plate 3 and the showerhead 5 to ports that are not aligned and thus not in direct communication are not shown in FIG. 1. However, a seal could be added to the design for cases when gas leakage between the un-aligned ports is not allowed.

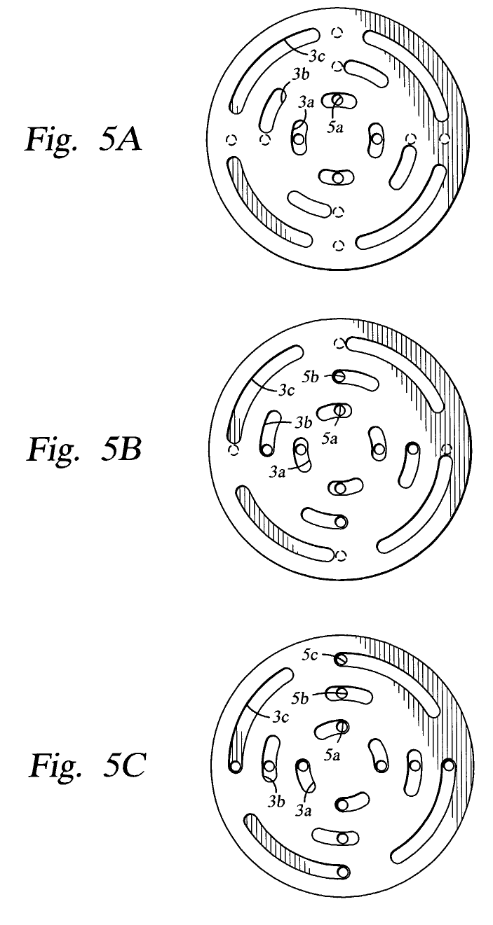

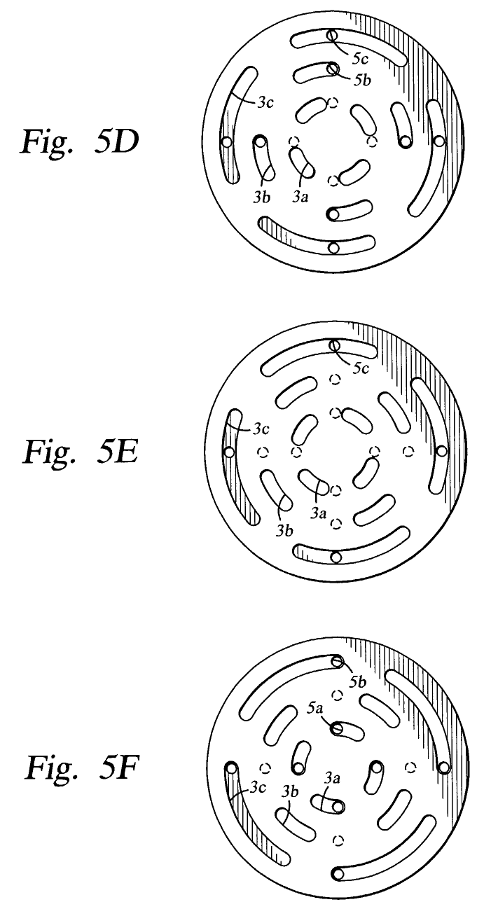

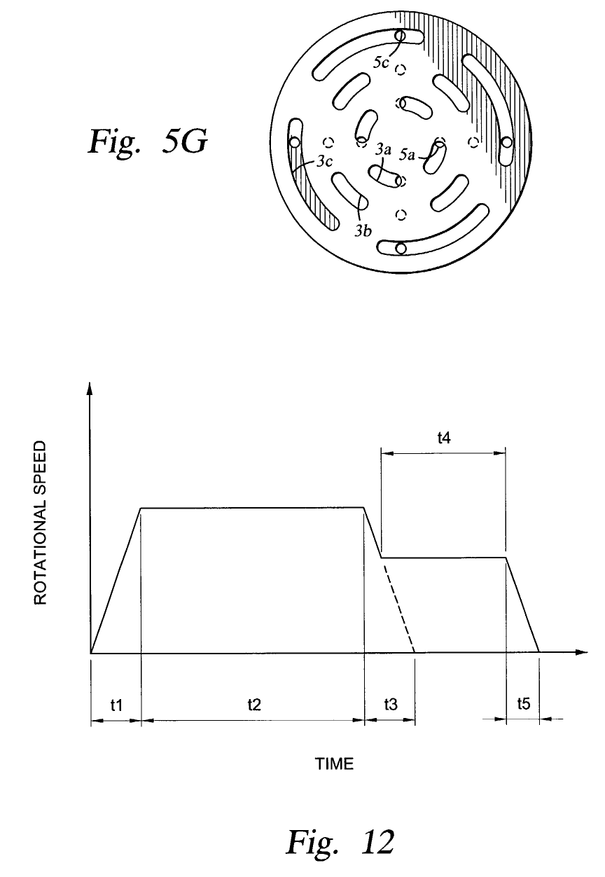

FIG. 5 highlights one embodiment of the present invention where angular orientation of the gas distribution plate 3 relative to the outlet ports of the showerhead 5 is used to control the gas distribution across the substrate 21. Such control is effected by controlling which slots and ports are in communication and thus which ports the gas will be allowed to flow through. FIG. 5A is a configuration where only the inner showerhead ports 5a are aligned with the gas source 162 through slots 3a. Therefore, gas entering the gas distribution plenum 2a exits the gas channel plate 2, flows through the slots 3a and into the chamber through the showerhead ports 5a. In FIG. 5B a configuration is shown in which the slots 3a is aligned with showerhead ports 5a and slots 3b is aligned with showerhead ports 5b thus only allowing gas to flow into the chamber through the innermost and second innermost (middle) chamber ports. In FIG. 5C a configuration is shown in which gas flows equally from all ports into the chamber since slots 3a, 3b and 3c are aligned with showerhead ports 5a, 5b and 5c, respectively. In FIG. 5D, a configuration is shown where gas is allowed to flow into the chamber through the middle and outer showerhead ports since slots 3b and 3c are aligned with showerhead ports 5b and 5c, respectively. In FIG. 5E a configuration is shown where the gas only enters the chamber through the outer ports 5c since they are aligned with slots 3c. In FIG. 5F a configuration is shown which allows slots 3a and 3c to be in communication with showerhead ports 5a and 5c, respectively. It is possible to for one skilled in the art to envision a number of configurations and combinations of ports with various circumferential positions and radial positions given the embodiments disclosed herein.

FIG. 5G illustrates an embodiment of this invention in which one or more of the slots in the gas distribution plate 3 can be configured such that they partially cover corresponding showerhead ports, where other slots are positioned to allow unrestricted flow to some ports and no flow (or completely restricted flow) to others. The FIG. 5G describes one possible embodiment where the ports 5a are partially covered by slots 3a, ports 5b are covered, and ports 5c is aligned with slots 3c and thus are completely open. The general embodiment described in FIG. 5G allows the partial obstruction of the showerhead ports to balance or restrict the flow through one port (or group of ports) relative to another port or group of ports. This gives the user the ability to vary the outlet port configuration and also the relative amount of flow between ports, or groups of ports, depending on the slot configuration in the gas distribution plate 3.

One embodiment of the present invention allows the user manually to adjust the port configuration by adjusting the position of the gas distribution plate 3 relative to the showerhead 5. It is envisioned in this embodiment that the user could manipulate the position of the gas distribution plate 3 relative to the showerhead 5 by use of tools, such as a wrench mated to flats on the gas channel plate, or by hand. The ability manually to adjust the gas flow distribution can be a cost effective method to control processes that are stable and when gas flow distribution is not changed frequently. As described above, it is possible to envision that the rotational position could be manually or automatically adjusted prior to each substrate processing cycle in the chamber if so required.

FIG. 6 shows an embodiment where an air cylinder 23 is used to separate the gas distribution plate 3 and the showerhead 5 leaving a gap 16 between the gas distribution plate 3 and the showerhead 5 so that particles will not be generated from the relative sliding motion between the two parts as they are being oriented. In this embodiment it is envisioned that the gas distribution assembly 17, containing the gas distribution plate 3, can be lifted from the showerhead 5 when the chamber is under vacuum or at atmospheric pressure. The air cylinder 23 supplies the force to lift the gas channel plate 2 by pushing against a mount (not shown) attached to the chamber lid 4. By use of a bearing or roller (not shown) attached to the end of the air cylinder 23 that contacts the gas channel plate 2, the gas channel plate 2 can be rotated while the air cylinder 23 is lifting it. As described above it is possible to envision that the position could be manually or automatically adjusted prior to each substrate processing cycle in the chamber if so required.

An aspect of the present invention is to allow the user to align the desired ports in the gas distribution plate 3 and the showerhead 5 in a precise and repeatable manner. As shown in FIG. 7, by use of a Spring Plunger(s) 15, purchased from Jergens Inc. in Cleveland, Ohio, and machined recesses 1c in the body of the gas inlet manifold 1, each desired rotational position can be found by the positive engagement of the tip of the Spring Plunger with a corresponding machined recess 1c in the gas inlet manifold 1. At least one single machined recess 1c will correspond to each desired port configuration. The use of features or markings machined on the side of the gas inlet manifold 1 and the gas channel plate 2 assures the user that the outlet port configuration, adjusted by use of a tool or by hand, is in the correct orientation.

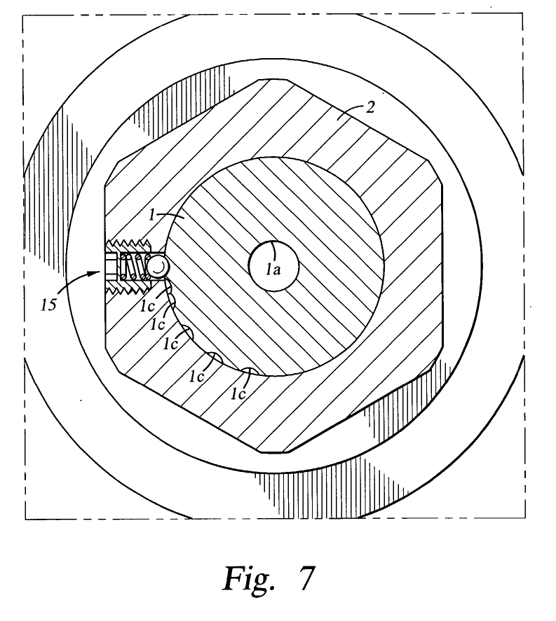

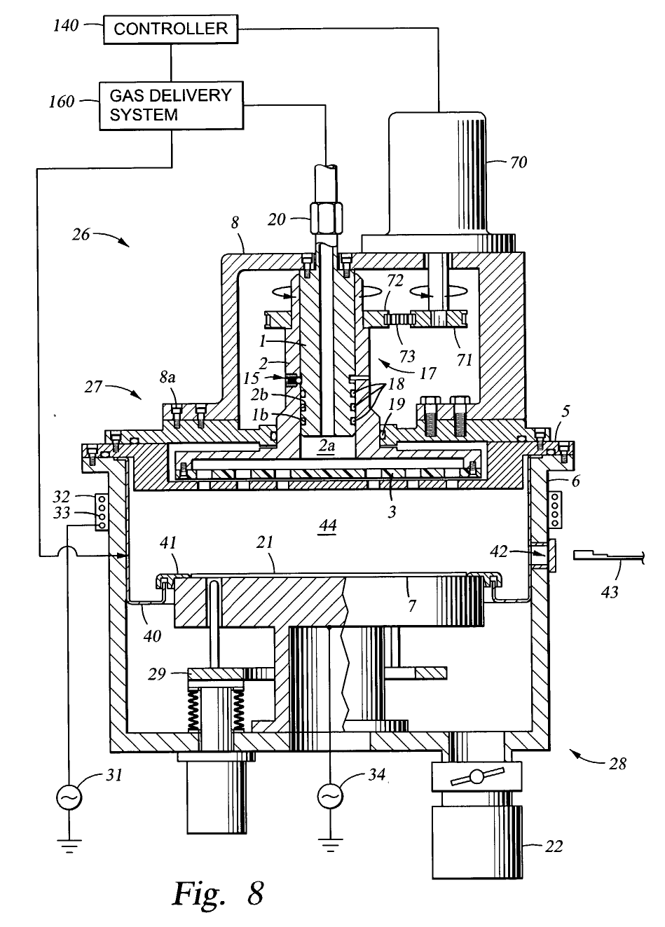

FIG. 8 is an embodiment in which the rotational position of the gas channel plate can be controlled automatically through the use of a motor 70 and the control system 140. In an exemplary automatic control design, a servo or stepper motor is used to control the rotation of the gas distribution assembly 17. In this embodiment, instead of manually rotating the head assembly, a motor 70 is coupled to the gas channel plate 2, such that any angular rotation of the motor 70 will directly translate into a rotation of the complete gas distribution assembly 17. As shown in FIG. 8, a possible method used to couple the motor 70 to the gas channel plate 2 is through use of a belt 73 attached to a first pulley 71, which is attached to the motor 70, and a second pulley 72 which is attached to the gas channel plate 2 of the gas distribution assembly 17. The position of the motor 70, and thus the directly-coupled gas distribution assembly 17, can be controlled and adjusted by use of a control system 140 which can monitor the motor position by use of an encoder or resolver and a feedback loop (not shown). By use of a control system it is possible for the user to adjust the position of the gas distribution assembly 17 during maintenance, just prior to running a process, or during the process sequence. It is possible to envision the user defining a process where the gas distribution assembly 17 could be reoriented by use of the controller 140 during a process step, after each process step, after multiple process steps, or change its position after many successive process cycles.

As stated above, the processing steps of the embodiments described herein may be performed in an integrated processing platform such as the eMAX™ platform available from Applied Materials, Inc. of Santa Clara, Calif. To facilitate the control and automation of the overall system, the integrated processing system may include a controller 140 comprising a central processing unit (CPU) 142, memory 144, and support circuits 146. The CPU 142 may be one of any form of computer processors that are used in industrial settings for controlling various chamber processes and hardware (motors, gas delivery hardware (mass flow controllers, etc.), etc.) and monitor the system and chamber processes (pressures, power, etc.). The memory 144 is connected to the CPU 142, and may be one or more of a readily available memory such as random access memory (RAM), read only memory (ROM), floppy disk, hard disk, or any other form of digital storage, local or remote. Software instructions and data can be coded and stored within the memory 144 for instructing the CPU 142. The support circuits 146 are also connected to the CPU 142 for supporting the processor 142 in a conventional manner. The support circuits 146 may include cache, power supplies, clock circuits, input/output circuitry, subsystems, and the like.

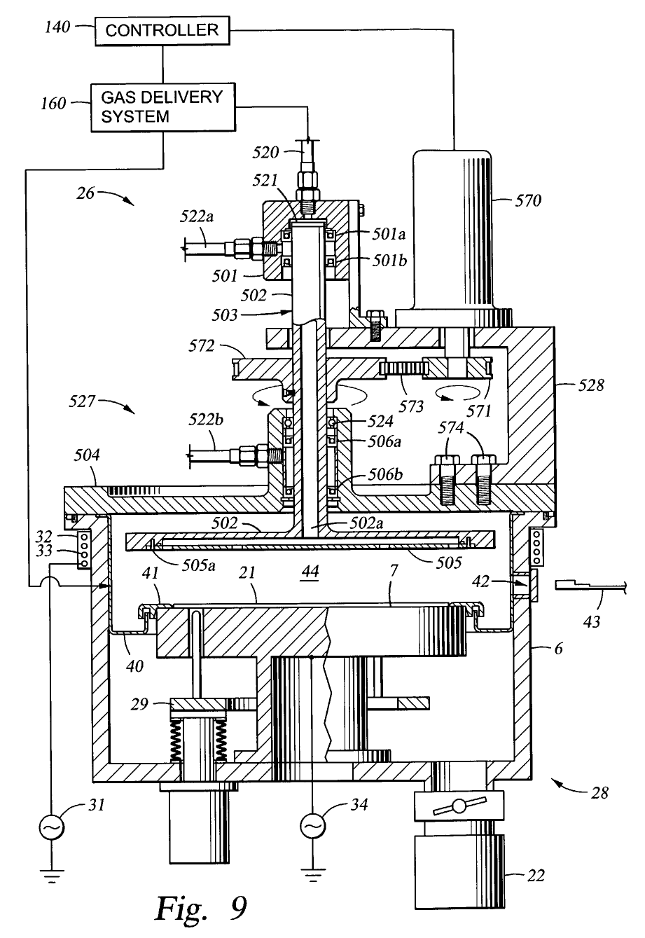

FIG. 9 is an embodiment in which the showerhead 505 is continually rotated by use of a control system and a motor during the process cycle to average out local non-uniformity caused by the use of discrete showerhead 505 gas injection ports. The non-uniformity arises from the inability to form a uniform flow distribution due to, for example, use of a finite number of showerhead 505 gas injection ports local to the surface of the substrate 21. The present embodiment also encompasses the use of radially staggered rotationally overlapping ports, and the rotation of the showerhead 505 will tend to average out the local non-uniformities caused by the gas flow distribution.

In the embodiment described in FIG. 9, the gas (or mixture of gases) that is supplied from a gas source 162, is delivered into the chamber through the gas inlet connection 520, gas-coupling assembly 501 and the gas distribution assembly 503. The gas entering through the gas inlet connection 520 flows through the gas-coupling assembly 501, into the inner gas channel 502a and through a plurality of ports in the showerhead 505, thus exiting into the process area 44 of the chamber. In one embodiment, a gas distribution assembly 503 contains a gas channel plate 502 and a showerhead 505 found on the bottom surface of the gas channel plate by use of a plurality of bolts 505a. In another embodiment (not shown) the gas distribution assembly 503 is an inseparable assembly containing a gas channel plate 502 and a showerhead 505 mounted to the bottom surface of the gas channel plate 502. The gas distribution assembly 503 is mounted to the chamber lid 504 by a bearing 524 to allow the assembly to freely rotate about the axis of the hole in the chamber lid 504. The upper rotary lip seal 506a and lower rotary lip seal 506b are mounted to the chamber lid 504 and the gas distribution assembly 503, to prevent leakage between the rotatable gas distribution assembly 503 and the chamber lid 504 due to the atmospheric pressure outside the process chamber 26. A vacuum port 522b formed in the chamber lid 504 allows the space between seals 506a and 506b to be differentially pumped to reduce the amount of leakage across the seals.

In another embodiment a porous metal filter 521, such as purchased from Mott Metallurgical Corporation, Farmington, Conn., is mounted to the upper end of the gas channel plate 502, to prevent particles generated from the gas-coupling assembly 501 or from other external components from being carried by the incoming gas into the process area 44 and onto the substrate 21's surface.

Further, FIG. 9 illustrates a stationary gas-coupling assembly 501 that generally includes of a housing 530, an upper rotary lip seal 501a, a lower rotary lip seal 501b and a vacuum port 522a. The rotary lip seal 501a and 501b seal against the rotatable gas channel plate 502 and the housing 530, thus preventing or minimizing atmospheric leakage into the chamber through the gas distribution assembly 503. The vacuum port 522a is incorporated into the design to differentially pump the space between the seals 501a and 501b to reduce the amount of leakage across the seals. Rotary lip seals 506a, 506b, 501a and 501b can be purchased from such manufacturers as Bal Seal Engineering, Foothill Ranch, Calif. It is also possible for one skilled in the art to envision substituting the complete stationary gas-coupling assembly 501 with a Ferrofluidic seal design as purchased form FerroTec, Nashua, NH or Kurt J. Lesker Company, Clairton, Pa.

The preferred embodiment described above allows the continual rotation of the showerhead during processing to even out localized effects of gas introduction into the chamber through the discrete showerhead ports. As shown in FIG. 9, one possible embodiment couples the motor 570 to the rotatable gas channel plate 502 through use of a belt 573 attached to a first pulley 571, which is attached to the motor 570, and a second pulley 572, which is attached to the rotatable gas channel plate 502 of the gas distribution assembly 503. The position of the motor 570, and thus the directly-coupled gas distribution assembly 503, can be controlled and adjusted by use of a control system 140 which can monitor the motor rotational position, velocity and acceleration by use of an encoder or resolver and a feedback loop (not shown).

By use of a control system, it is possible to optimize the uniformity for each gas mixture or flow rate by varying the rotational speed to compensate for variations in one or many process variables. An example of a possible rotational speed profile is shown in FIG. 12 where the rotational speed is varied over different time intervals possibly correlating to a process step or whole wafer-process cycle. FIG. 12 describes a possible rotational speed profile for the showerhead 505 during a process step or process recipe where the showerhead 505 rotational speed can be varied through the process (Times t1, t3, t5), and/or held at various constant speed (Times t2 and t4). It is within the scope of the present invention that the rotational speed can be varied after each process variable is changed, during a process step, after a successive number of steps or after a successive number of process cycles to compensate for variables causing process drift. The list described here is not an all-inclusive list and one skilled in the art may envision a number of possible variations depending on the desired process effect to be achieved by the rotation of the showerhead assembly.

FIG. 13 is a cross-sectional view of one embodiment of a capacitively-coupled plasma chamber design. The embodiment shown is similar to the inductively-coupled chamber design shown in FIG. 2 except that the lid assembly 27, and more specifically in most cases the showerhead 5 or the chamber lid 4, are made from a conductive material such as anodized aluminum (or a ceramic material with imbedded electrodes (not shown)) and the RF source 31 is electrically connected to the lid assembly 27 instead of to an inductive coil 33. The conductive material in the lid assembly 27 allows the RF potential placed on the upper chamber component(s) to act as the anode in the generation and sustaining of a plasma contained in the process area 44. The biased components are generally covered, coated or have the surfaces modified to resist chemical attack from the injected gases and physical bombardment from the ions generated in the plasma. In this embodiment the lid assembly 27 is isolated from the lower chamber assembly 28 by use of an electrically insulating spacer 550 that mounts, seals and electrically isolates the lid assembly 27 from the lower chamber assembly 28.

FIG. 14 is a cross-sectional view of another embodiment of a capacitively coupled plasma chamber design for the continuously rotated showerhead embodiment, described in FIG. 12. The embodiment shown in FIG. 14 is similar to the inductively coupled chamber design except that the lid assembly 527, and more specifically and in most cases the gas distribution assembly 503 or the chamber lid 504, are made of a conductive material such as anodized Aluminum (or a ceramic material with imbedded electrodes (not shown)). The conductive material in the lid assembly 527 allows the RF potential placed on the upper chamber component(s) to act as the anode in the generation and sustaining of a plasma contained in the process area 44. The biased components are generally covered, coated or have the surfaces modified to resist chemical attack from the injected gases and physical bombardment from the ions generated in the plasma. A rotating electrical coupling 541 is incorporated into the assembly to electrically connect the gas distribution assembly 503 to the RF source 31. The rotating electrical coupling 541, generally described in the art as a slip ring, can be purchased from IDM Electronics LTD, Reading Berkshire, England, a division of Kaydon Corporation, Ann Arbor, Mich.

While the foregoing is directed to the preferred embodiment of the present invention, other and further embodiments of the invention may be devised without departing from the basic scope thereof, and the scope thereof is determined by the claims that follow.

1. A gas distribution system for delivering a gas to a process chamber, comprising:
a gas inlet port connected to a gas source;
a first plate having a bottom and a top rotationally coupled to the gas inlet port forming an internal plenum, wherein the first plate contains a plurality of slots that connect the plenum and the bottom;
a showerhead located adjacent to a substrate supporting surface and the bottom surface of the plate, wherein the showerhead has a plurality of one or more spaced ports capable of aligning with the slots of the first plate; and
a gas flow path from the gas source through the gas inlet port through the slots in the first plate aligned with the ports of the showerhead.

2. The gas distribution system in claim 1, wherein the first plate is rotated to align the slots in the first plate and the ports in the showerhead.

3. The gas distribution system in claim 1, further comprising a controller, wherein the controller controls the inlet gas flow rate and gas mixture ratio by use of a mass flow controller.

4. The gas distribution system in claim 1, wherein the gas distribution is non-uniform due to the alignment of the slots of the first plate and the ports in the showerhead.

5. The gas distribution system in claim 1, wherein the first plate is rotated to partially align with one or more ports in the showerhead.

6. The gas distribution system in claim 5, wherein the remaining ports are completely aligned or completely not aligned.

7. The gas distribution system in claim 1, wherein the alignment of the slots of the first plate with the ports on the showerhead is manually controlled.

8. The gas distribution system in claim 1, further comprising features in the gas inlet port and the first plate which positively engage to rotationally position the first plate and the showerhead.

9. The gas distribution system in claim 1, further comprising alignment marks on the first plate and the showerhead.

10. The gas distribution system in claim 1, wherein the first plate is constructed from two parts where a first part containing a top and a bottom is rotationally coupled to a gas inlet port, and a second part contains a plurality of slots and is mounted on the bottom of the first part so that the second part can be removed and replaced.

11. A gas distribution system for delivering a gas to a processing chamber, comprising:
a gas inlet port connected to a gas supply;
a first plate having a bottom and a top rotationally coupled to the gas inlet port forming an internal plenum, wherein the first plate contains a plurality of slots that connect the plenum and the bottom;
a showerhead located adjacent to a substrate supporting surface and the bottom surface of the plate, wherein the showerhead has a plurality of one or more spaced ports capable of aligning with the slots of the first plate;
a gas flow path from the gas source through the gas inlet port through the slots in the first plate aligned with the ports of the showerhead;
a motor which is rotationally coupled to the first plate capable of adjusting the rotational position of the first plate; and
a controller system, having a controller, wherein the controller by use of control commands adjusts the rotational position of the first plate relative to the showerhead by use of a motor and the inlet gas flow rate and gas mixture ratio by use of a mass flow controller.

12. The gas distribution system in claim 11, wherein the rotational position of the first plate is adjusted at defined intervals by use of the controller.

13. A gas distribution system for delivering a gas to a processing chamber, comprising:
a gas inlet port connected to a gas source;
a first plate having a bottom and a top, containing an internal plenum, wherein the bottom of the first plate contains a plurality of ports formed into it that connect the plenum and the bottom, and the bottom is located adjacent to a substrate supporting surface;
a stationary gas feed through rotationally coupled to the first plate containing radially disposed seals to prevent atmospheric leakage into the plenum formed between the stationary gas feed through and the top of the first plate, and also to contain the gas exiting the inlet port from the gas source allowing it to flow into the internal plenum of the first plate;
a gas flow path from the gas source through the gas inlet port through the stationary gas feed into the gas plenum and out into the chamber through the ports of the ports in the bottom surface of the first plate;
a motor which is rotationally coupled to the first plate to adjust the rotational position of the first plate; and
a controller system, having a controller, wherein the controller by use of commands, adjusts the rotational position of the first plate relative to the showerhead by use of the motor, and adjusts the inlet gas flow rate and gas mixture ratio by use of a mass flow controller.

14. The gas distribution system in claim 13 where the motor rotates the first plate continually.

15. The gas distribution system in claim 13 where the motor rotates the first plate at various rotational speeds during processing by use of commands from the controller.

16. The gas distribution system in claim 15 where the rotation velocity is adjusted during processing to achieve a desired gas distribution by a controller.

17. The gas distribution system in claim 15 where the rotational acceleration and velocity is adjusted during processing by a controller.

18. The gas distribution system in claim 13, wherein the first plate is constructed from two parts where a first part containing a top and a bottom is rotationally coupled to the stationary gas feed through and a second part which contains a plurality of ports and is mounted on the bottom of the first part so that the second part can be removed and replaced.
